(19) United States
(12) Patent Application Publication
(10) Pub. No.: US 2009/0188504 A1
(43) Pub. Date: Jul. 30, 2009

(54) MECHANICALLY ACTUATED EMERGENCY OXYGEN DELIVERY SYSTEM

(76) Inventor: William D. Siska, JR., Elma, NY (US)

Correspondence Address: JAECKLE FLEISCHMANN & MUGEL, LLP, 12 Fountain Plaza, Buffalo, NY, 14202-2292, US

(21) Appl. No.: 12/020,144

(22) Filed: Jan. 25, 2008

(51) Int. Cl. A62B 7/02

(52) U.S. Cl. 128/205.21

(57) ABSTRACT

An emergency oxygen system includes: a pressure vessel containing pressurized oxygen; a rupturable seal that confines the oxygen within the vessel until the seal is ruptured; and a valve assembly for controlling the oxygen release and delivery to an aircraft passenger. The valve assembly includes: a valve body with an oxygen outlet connected to the pressure vessel; and a threaded poppet mounted within the valve body whose first end is a pierce point in contact with the seal. The system further includes a pulley that is rotatably connected to the valve body and engages the second end of the poppet; a cable attached to the pulley to effect its rotation; and an oxygen breathing mask connected to the oxygen outlet. Actuation of the cable causes the pulley to rotate and the threaded poppet to move laterally towards the seal, which results in rupture of the seal and allows oxygen to flow through the oxygen outlet to the mask.

### FIELD OF THE INVENTION

The present invention relates to oxygen delivery systems and, more particularly, to a mechanically actuated, pressurized oxygen emergency delivery system for use in aircraft.

### BACKGROUND OF THE INVENTION

Emergency oxygen supply systems are installed on aircraft to supply oxygen to passengers upon loss of cabin pressure at altitudes above about 12,000 feet. The emergency oxygen supply devices typically include a source of supplemental breathable oxygen connected to a face mask that is released from an overhead storage compartment when needed. The flow of breathable oxygen should be sufficient to sustain passengers until cabin pressure is reestablished or until a lower, safer altitude can be reached.

Typically, the oxygen supply devices are tightly bundled to fit within an overhead compartment above the seats of the passengers. Upon encountering an emergency situation such as reduced cabin pressure, a door to the compartment opens, and the oxygen supply devices drop down and dangle by flexible hoses connected to a breathing oxygen source. A seated aircraft passenger then dons a breathing mask that is included with the device to begin receiving oxygen from the oxygen source, which is typically either a chemical oxygen generator or a tank of pressurized oxygen. The pressurized oxygen may be delivered to the supply devices via a plumbed system from a central source, or from individual oxygen tanks located within the overhead compartments.

Commonly employed oxygen supply devices that supply breathing oxygen to aircraft crew and passengers from a plumbed oxygen source via drop-down cup-shaped masks are described in, for example, International Application WO 2004/028586, U.S. Pat. No. 6,247,471, and U.S. Pat. No. 5,301,665, the disclosures of which are incorporated herein by reference.

Other emergency oxygen delivery apparatus and systems are described in the following patents and applications, the disclosures of which are incorporated herein by reference:

U.S. Pat. No. 4,233,970 discloses a breathing apparatus that includes a protective hood for the head of a wearer and a cylinder of pressurized oxygen-enriched air. The flow control valve connecting the air source to the hood is manually operated by the wearer, and the pressure within the cylinder may be monitored by a Bourdon tube.

UK Patent Application GB 2193644 discloses a combined gas release and gas pressure measuring device connected to a pressurized gas cylinder and preferably used together with a breathing mask and flexible hood. Gas is released from the cylinder by gripping a knob and moving it to break a seal in a gas delivery tube. Gas pressure is measured by a Bourdon tube included in the device.

UK Patent Application GB 2119660 discloses a protective covering that has a helmet part and a body part, together with a sealed oxygen cartridge on a chest portion of the body part. The cartridge is opened by the wearer's actuation of a lever attached to an actuation cord, thereby causing a pointed pin to move against the force of a spring and pierce a membrane sealing the cartridge. The pressure of the released oxygen is reduced by a metering throttle.

U.S. Pat. No. 1,917,958 discloses an oxygen supply system for an aircraft that, in the event of failure of the oxygen flow regulator, provides a by-pass through which oxygen can flow following the piercing of a diaphragm in the by-pass passage by a cam-actuated plunger.

U.S. Patent Appl. Publ. No. 2007/0084463 discloses a breathing apparatus that includes a protective hood and a cylinder of compressed oxygen, wherein the flow of oxygen to the hood is started by actuating a spring biased pin that punctures a gasket of the cylinder. The apparatus also includes an air pump that operates as a Venturi device whose operation is based on the release of oxygen from the cylinder.

U.S. Pat. No. 4,619,255 discloses an emergency oxygen supply system for use on an aircraft having an ejection seat that includes a primary oxygen supply source, an emergency oxygen supply means, and an oxygen mask wherein the emergency oxygen supply means is affixed to the ejection seat.

### SUMMARY OF THE INVENTION

The present invention is directed to a aircraft passenger emergency oxygen system that comprises: a pressure vessel containing pressurized oxygen; a rupturable seal that confines the pressurized oxygen within the vessel until the seal is ruptured; and a valve assembly for controlling the release of oxygen from the pressure vessel and delivering oxygen to an aircraft passenger. The valve assembly comprises: a valve body sealably connected to the pressure vessel and provided with an oxygen outlet; and a threaded poppet that is mounted within the valve body and has a first end comprising a pierce point in contact with the rupturable seal.

The emergency oxygen system further comprises a pulley rotatably connected to the valve body and disposed to engage a second end of the threaded poppet; an actuation cable attached to the pulley to effect its rotation; and at least one oxygen breathing mask flexibly connected to the oxygen outlet.

Actuation of the actuation cable causes the pulley to rotate and the pierce point of the threaded poppet to move against the seal, causing the seal to rupture and allowing oxygen to flow from the pressure vessel into the valve body, and thence through the oxygen outlet to at least one oxygen breathing mask.

### BRIEF DESCRIPTION OF THE DRAWINGS

FIG. 1 is a block diagram depicting the components of the aircraft passenger emergency oxygen system of the present invention.

FIG. 2 is a schematic cross-section of the pressure vessel, seal, and valve assembly of the emergency oxygen system.

FIG. 3 is a schematic perspective view of the pressure vessel and valve assembly of the emergency oxygen system.

### DETAILED DESCRIPTION OF THE INVENTION

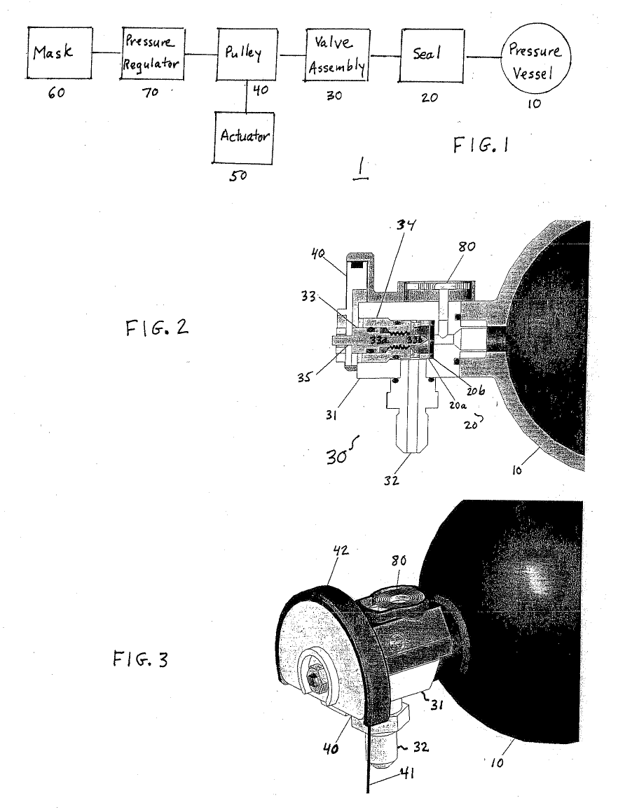

As schematically depicted in FIG. 1, the aircraft passenger emergency oxygen system 1 of the present invention includes a pressure vessel 10 containing pressurized oxygen, a rupturable seal 20 that confines the pressurized oxygen within the vessel 10 until the seal 20 is ruptured, a valve assembly 30 for controlling the release of oxygen from the pressure vessel 10, a pulley 40 whose actuation by an actuator cable 50 causes rupture of seal 20 and the flow of oxygen to at least one oxygen breathing mask 60, which preferably comprises a plurality of masks. An optional pressure regulator 70, well known in the art, controls the pressure of oxygen delivered to the oxygen breathing mask 60.

As shown in FIG. 2, valve assembly 30 includes a valve body 31 sealably connected to the pressure vessel 10 and provided with an oxygen outlet 32, and a threaded poppet 33, preferably a lead screw 33a that is mounted within seat retainer 34 of valve body 31. Poppet 33 has a first end comprising a pierce point 33a in contact with the rupturable seal 20, which is preferably a burst disk 20a and further includes a soft metal seal 20b. Pulley 40 is rotatably connected to valve body 31 and disposed to engage threaded poppet 33 via a keyed interface 35.

FIG. 2 also depicts an optional pressure measuring device 80, preferably a Bourdon tube, for determining the pressure of oxygen within pressure vessel 10. Given that the pressure vessel is intended to be “sealed for life,” i.e. a period of about 15 years, such a device would be useful for monitoring the oxygen pressure within vessel 10 over the useful lifetime of the aircraft passenger emergency oxygen system 1. The rupturable seal 20, preferably comprising burst disk 20a and soft metal seal 20b, allows for the gradual relief of pressure in pressure vessel 10 in the unlikely event of a fire. Seal 20 is manually/mechanically punctured to activate the system, no electrical power being necessary for this purpose.

As depicted in FIG. 3, an actuation cable 41 attached to pulley 40 to effect its rotation, which causes threaded poppet 33 (FIG. 2) to move laterally against seal 20, rupturing it and thereby allowing oxygen to flow from pressure vessel 10 into valve body 31, and thence through oxygen outlet 32 to oxygen breathing mask 60 (FIG. 1).

FIG. 3 also depicts an optional protective guard 42 for pulley 40.

Pressure vessel 10, which is preferably a DOT-approved steel 3HT cylinder, contains pressurized oxygen at approximately 3,600 psig. An exemption will be requested from the DOT to remove any re-hydro testing of the cylinder, as its intended use entails a single filling. Preferably, two cylinder sizes are to be available, with expanded oxygen volume at atmospheric pressure of about 154 liters and about 231 liters. These cylinder sizes are suitable for supplying two and three breathing masks, respectively.

During a decompression event on board the aircraft, actuator cables 50 and emergency breathing masks 60, which are stored along with the rest of the emergency oxygen system 1 in an overhead compartment located above a row of passenger seats, will drop down in front of the seated passengers. When an actuator cable 50 is pulled, the pulley 40 is rotated, which in turn forces the pointed poppet 33 through seal 20 and allows for a controlled turn-on rate. Following actuation, the optional pressure regulator 70 regulates the cylinder pressure from 3,600 psig to a value necessary to control the flow of oxygen for several of the masks 60, whose flow capacity will be from about 2.75 liters/minute to about 0.02 liter/minute, depending on altitude. The pressure regulator 70 preferably provides altitude compensation through the use of an aneroid (not shown), which helps optimize the flow of oxygen as altitude changes.

The aircraft passenger emergency oxygen system of the present invention, which includes a “sealed for life” oxygen pressure vessel, avoids the high cost of installing and maintaining an emergency system having a plumbed oxygen supply. In addition, the present system greatly facilitates the reconfiguration of the seating arrangement on an aircraft that may be required by, for example, modification of its seating capacity.

While the invention has been described by reference to various specific embodiments, it should be understood that numerous changes may be made within the spirit and scope of the inventive concepts described. Accordingly, it is intended that the invention not be limited to the described embodiments, but will have full scope defined by the language of the following claims.

What is claimed:

1. An aircraft passenger emergency oxygen system comprising:
a) a pressure vessel containing pressurized oxygen under pressure;
b) a rupturable seal that confines said pressurized oxygen within said vessel until said seal is ruptured;
c) a valve assembly for controlling release of said oxygen from said pressure vessel and delivering said oxygen to an aircraft passenger, said valve assembly comprising: a valve body sealably connected to said pressure vessel and provided with an oxygen outlet; and a threaded poppet mounted within said valve body, said poppet having a first end comprising a pierce point in contact with said rupturable seal;
d) a pulley rotatably connected to said valve body and disposed to engage a second end of said threaded poppet;
e) an actuation cable attached to said pulley to effect rotation of said pulley; and
f) at least one oxygen breathing mask flexibly connected to said oxygen outlet;
wherein actuation of said actuation cable causes said pulley to rotate and said threaded poppet to move laterally against said seal, rupturing said seal and thereby allowing oxygen to flow from said pressure vessel into said valve body, and thence through said oxygen outlet to said at least one oxygen breathing mask

2. The aircraft passenger emergency oxygen system of claim 1 wherein said rupturable seal comprises a burst disc.

3. The aircraft passenger emergency oxygen system of claim 2 wherein said rupturable seal further comprises a soft metal seal in contact with said burst disc.

4. The aircraft passenger emergency oxygen system of claim 1 further comprising a pressure measuring device for determining the pressure of oxygen within said pressure vessel.

5. The aircraft passenger emergency oxygen system of claim 4 wherein said pressure measuring device comprises a Bourdon tube.

6. The aircraft passenger emergency oxygen system of claim 1 further comprising a pressure regulating device for controlling the pressure of oxygen delivered to said at least one oxygen breathing mask.

7. The aircraft passenger emergency oxygen system of claim 6 wherein said pressure regulating device further comprises an aneroid.

8. The aircraft passenger emergency oxygen system of claim 1 wherein said at least one oxygen breathing mask comprises a plurality of masks.

9. The aircraft passenger emergency oxygen system of claim 1 wherein said pulley engages said second end of said threaded poppet via a keyed interface.

10. The aircraft passenger emergency oxygen system of claim 1 wherein said pressure vessel has a capacity of about 154 liters to about 231 liters of expanded oxygen at atmospheric pressure.

11. The aircraft passenger emergency oxygen system of claim 1 wherein said system is installed in a compartment above a row of aircraft passenger seats.
